(19) United States
(12) Patent Application Publication
(10) Pub. No.: US 2025/0198201 A1
(43) Pub. Date: Jun. 19, 2025

(54) LOCKING DEVICE

(71) Applicant: PAOKAI ELECTRONIC ENTERPRISE CO., LTD., Kaohsiung City (TW)

(72) Inventors: Ming-Shan WEI, Kaohsiung City (TW); Tung-Ying WEI, Kaohsiung City (TW)

(73) Assignee: PAOKAI ELECTRONIC ENTERPRISE CO., LTD., Kaohsiung City (TW)

(21) Appl. No.: 18/599,590

(22) Filed: Mar. 8, 2024

(30) Foreign Application Priority Data
Dec. 13, 2023 (TW) 112213616

(51) Int. Cl. E05B 65/00

(52) U.S. Cl. CPC E05B 65/006

(57) ABSTRACT

A locking device adapted to be used on a claw machine cabinet that includes a window frame and a window panel having a frame portion that has an engaging slot. The locking device includes an operating unit including a cam member and a locking member, and an actuating unit including a base plate and a locking rod. The cam member is rotatable around a rotary axis, and has a long end and a short end. The cam member is rotatable between a first rotational position, where the long end abuts against the base plate, and pushes the locking rod to move to a locked position and engage the engaging slot, and a second rotational position, where the short end abuts against the base plate and releases the base plate to move the locking rod to an unlocked position, and disengages the locking rod from the engaging slot.

### CROSS-REFERENCE TO RELATED APPLICATION

This application claims priority to Taiwanese Utility Model Patent Application No. 112213616, filed on Dec. 13, 2023, the entire disclosure of which is incorporated by reference herein.

### FIELD

The disclosure relates to a locking device, and more particularly to a locking device for a claw machine cabinet.

### BACKGROUND

Referring to FIG. 1, a conventional locking device 1 is adapted to be used on a display cabinet 2. The display cabinet 2 includes a window frame 21, and a glass panel 22 that is openably disposed in the window frame 21, and that has an mounting hole 220 extending therethrough and adjacent to a side thereof. The conventional locking device 1 includes a fixed member 11 fixed to the window frame 21 and disposed at an interior side of the display cabinet 2, a driving rod 12 extending through the mounting hole 220, a hooked unit 13 connected to the driving rod 12 and disposed at an interior side of the display cabinet 2, and a locking member 14 disposed at the exterior side of the display cabinet 2, connected to the driving rod 12, and operable to be driven to rotate by a key (not shown) inserted therein. When the locking member 14 is rotated, the hooked unit 13 is driven to move between a locked position and an unlocked position. When the hooked unit 13 is in the locked position, the hooked unit 13 engages the fixed member 11 and prevents the glass panel 22 from moving relative to the window frame 21, thereby securing the glass panel 22 in place and keeping the display cabinet 2 closed. When the hooked unit 13 is in the unlocked position, the hooked unit 13 disengages from the fixed member 11, allowing the glass panel 22 to move relative to the window frame 21, and thus allowing the display cabinet 2 to be opened.

However, in order to mount the locking device 1 to the display cabinet 2, the mounting hole 220 is formed by cutting through the glass panel 22, so that the driving rod 12, the hooked unit 13, and the locking member 14 may be secured to the glass panel 22. A water jet cutter is used to cut a hole on the glass panel 22 after the glass panel 22 has been manufactured, which not only complicates the original manufacturing process of the structure of the glass panel 22 by adding an extra step, but also weakens the structural strength of the glass panel 22, which is disadvantageous for keeping the items in the display cabinet 2 safe.

### SUMMARY

Therefore, an object of the disclosure is to provide a locking device that can alleviate at least one of the drawbacks of the prior art.

According to the disclosure, the locking device is adapted to be used on a claw machine cabinet. The claw machine cabinet includes a window frame that defines a mounting space, and a window panel that is mounted in and openably covers the mounting space. The window frame has a receiving chamber that has an open hole. The window panel has a panel portion and a frame portion. The frame portion is fixedly connected to the panel portion and has an engaging slot facing the receiving chamber. The locking device includes an operating unit and an actuating unit. The operating unit includes a cam member and a locking member. The cam member is adapted to be disposed in the receiving chamber, is rotatable around a rotary axis, and has a long end that is a first distance away from the rotary axis, and a short end that is a second distance away from the rotary axis. The second distance is shorter than the first distance. The locking member is connected to the cam member and is operable for driving rotation of the cam member. The actuating unit is adjacent to the operating unit, and includes a base plate and a locking rod. The base plate is adapted to be disposed between the cam member and the open hole of the window frame, and abuts against the cam member. The locking rod is connected to the base plate and adapted to be aligned with the open hole of the window frame. The cam member is rotatable about the rotary axis between a first rotational position, where the long end abuts against the base plate, and a second rotational position, where the short end abuts against the base plate. When the cam member is rotated to the first rotational position, the base plate is pushed to move the locking rod to a locked position, where the locking rod is adapted to protrude outwardly of the open hole and to engage the engaging slot of the frame portion of the window panel. When the cam member is rotated to the second rotational position, the base plate is released to move the locking rod to an unlocked position, where the locking rod is adapted to be disengaged from the engaging slot.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary sectional view of a conventional locking device.

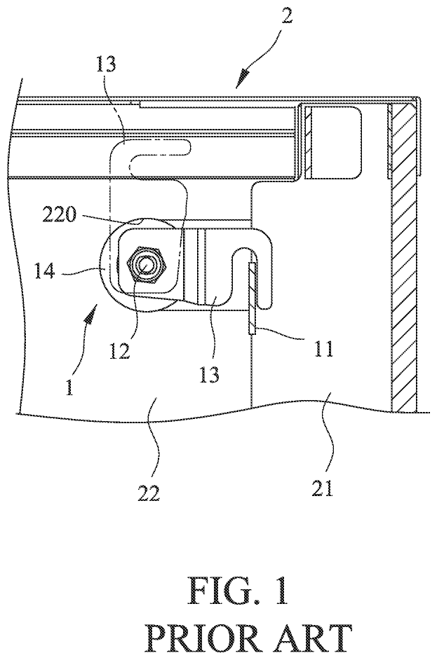

FIG. 2 is a fragmentary perspective view illustrating an embodiment of a locking device according to the disclosure.

FIG. 3 is a schematic view of a cam member.

FIG. 4 is a fragmentary side view of the embodiment, illustrating two locking rods in a locked position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

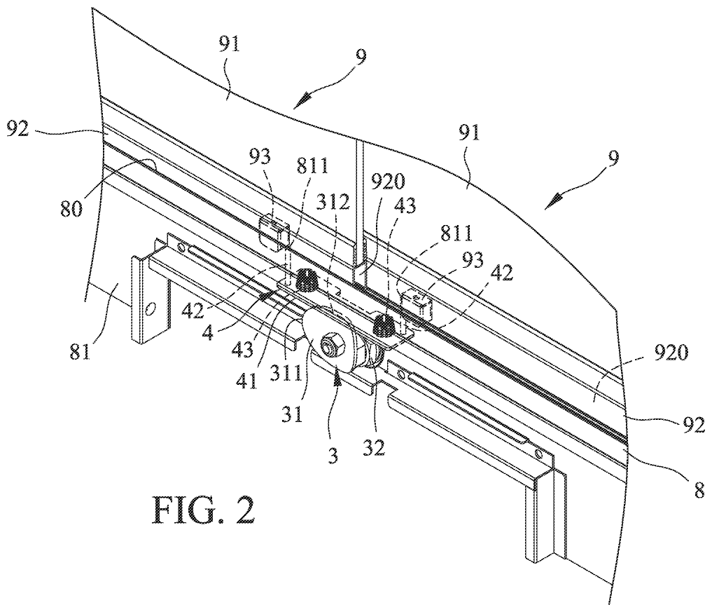

Referring to FIG. 2, an embodiment of a locking device according to the disclosure is adapted to be used on a claw machine cabinet. The claw machine cabinet includes a window frame 8 that defines a mounting space 80, and two window panels 9 that are parallelly mounted in and openably cover the mounting space 80. The window frame 8 has a receiving chamber 81 that has two open holes 811. Each window panel 9 has a panel portion 91, a frame portion 92 that is fixedly connected to the panel portion 91, and that has an engaging slot 920 facing the receiving chamber 81, and a blocking unit 93 that is fixedly disposed in the engaging slot 920. The locking device includes an operating unit 3 and an actuating unit 4 that is adjacent to the operating unit 3. It should be noted that, while the claw machine cabinet in this embodiment has two window panels 9, a number of the window panels 9 may be changed as needed in other embodiments.

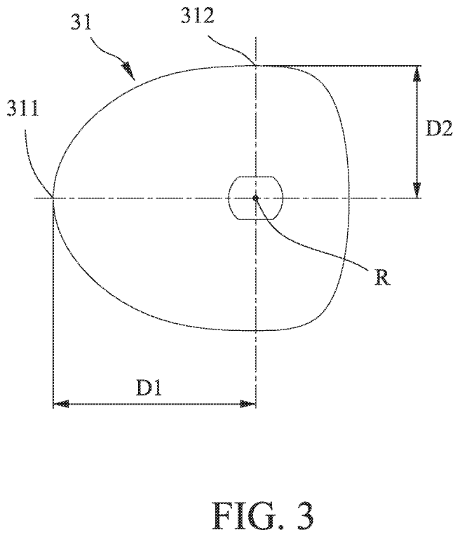

The operating unit 3 includes a cam member 31 adapted to be disposed in the receiving chamber 81, and a locking member 32 connected to the cam member 31 and operable for driving rotation of the cam member 31. Further referring to FIG. 3, the cam member 31 is rotatable about a rotary axis (R), and has a long end 311 that is a first distance (D1) away from the rotary axis (R), and a short end 312 that is a second distance (D2) away from the rotary axis (R). The second distance (D2) is shorter than the first distance (D1). Furthermore, the locking member 32 is substantially disposed on the rotary axis (R), has an end exposed to the external environment, and is a modular mechanism operable to be driven to rotate by a key (not shown) that is inserted into the locking member 32 via the end in the external environment; in other embodiments, the locking device may be other mechanisms that are operable from the end of the locking member 32 in the external environment for driving rotation of the cam member 31.

The actuating unit 4 includes a base plate 41, two locking rods 42, and two resilient members 43. The base plate 41 is adapted to be disposed between the cam member 31 and the open holes 811 of the window frame 8, and abuts against the cam member 31. The locking rods 42 are connected to the base plate 41, and are adapted to be respectively aligned with the open holes 811 of the window frame 8. The resilient members 43 are spaced apart from each other, and are adapted to be connected between the base plate 41 and an internal surface of the window frame 8. Since the embodiment includes two window panels 9, the two locking rods 42 are used to respectively engage the engaging slots 920 of the two window panels 9 in order to simultaneously lock the window panels 9 in place.

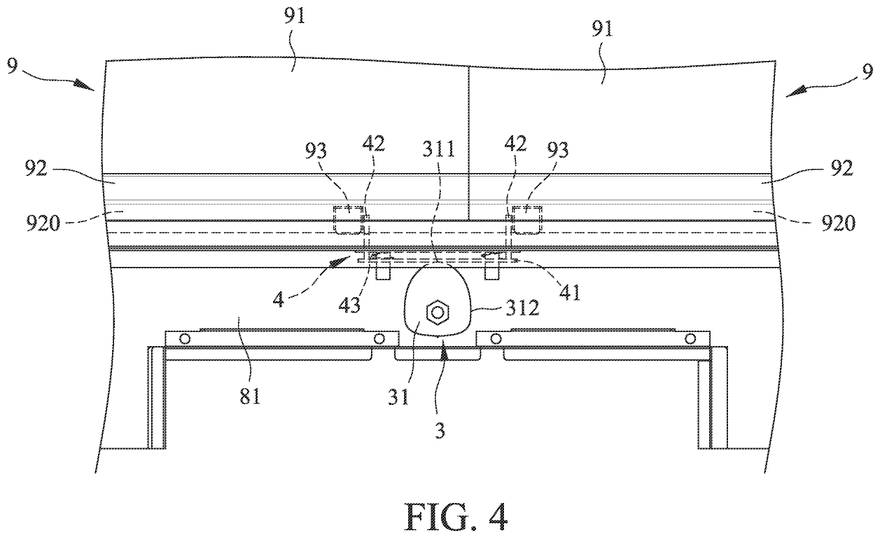

Referring to FIGS. 2 to 4, the lengths of the first distance (D1) and the second distance (D2) are designed according to the length of the locking rods 42. The cam member 31 is rotatable about the rotary axis (R) between a first rotational position (see FIG. 4), where the long end 311 abuts against the base plate 41, and a second rotational position (see FIG. 2), where the short end 312 abuts against the base plate 41. By virtue of the discrepancy between the lengths of the first distance (D1) and the second distance (D2), and the position of the base plate 41, rotation of the cam member 31 between the first rotational position and the second rotational position drives the locking rods 42 to move between a locked position and an unlocked position respectively.

Specifically, when the cam member 31 is rotated to the first rotational position (see FIG. 4), the base plate 41 is pushed to move the locking rods 42 to the locked position, where the locking rods 42 are adapted to respectively protrude outwardly of the open holes 811, and to respectively engage the engaging slots 920 of the frame portions 92 of the window panels 9. At this time, if the user moves the window panels 9, the blocking units 93 of the window panels 9 will be respectively blocked by the locking rods 42, thereby restricting movement of the window panels 9. When the cam member 31 is rotated to the second rotational position, the base plate 41 is released to move the locking rods 42 to the unlocked position, where the locking rods 42 are adapted to be respectively disengaged from the engaging slots 920, thereby unlocking the window panels 9 and allowing the window panels 9 to be unobstructedly moved and thus to be opened. Hence, by moving the locking rods 42 through the open holes 811 to switch between the locked position and the unlocked position, the movement of the window panels 9 may be restricted without damaging the panel portions 91 of the window panels 9, and by utilizing structures that are already included in the window panels 9 (the engaging slots 920, the blocking units 93 . . . , etc.), the objective of the disclosure is achieved.

Specifically, the resilient member 43 is a compression spring, and when the locking rods 42 are moved towards the locked position, the resilient member 43 is adapted to be pushed by the base plate 41 against the internal surface of the window frame 8, and to generate a force that biases the locking rods 42 towards the unlocked position, so that the base plate 41 may drive the locking rods 42 to move towards the unlocked position without considering the pull of gravity. Hence, the locking device may function, for example, in an inversed direction compared to a direction of the locking device in FIG. 4, in accordance to the configuration of the claw machine cabinet, or elements in the external environment, and without considering gravity. The locking device is functional as long as the locking rods 42 are operable for being moved to respectively engage the engaging slots 920 of the frame portions 92, thereby increasing versatility.

In conclusion, the locking device may be mounted to the claw machine cabinet without damaging the panel portions 91 of the window panels 9, thereby increasing the simplicity of the mounting process. Furthermore, by rotating the cam member 31 to the first and second rotational positions, the locking rods 42 are moved respectively through the open holes 811 to engage or be disengaged from the engaging slots 920 of the window panels 92, thus the locking rods 42 switch between the locked position and the unlocked position to lock or unlock the window panels 9, and thereby the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A locking device adapted to be used on a claw machine cabinet, the claw machine cabinet including a window frame that defines a mounting space, and a window panel that is mounted in and openably covers the mounting space, the window frame having a receiving chamber that has an open hole, the window panel having a panel portion, and a frame portion that is fixedly connected to the panel portion and that has an engaging slot facing the receiving chamber, the locking device comprising:
an operating unit that includes
a cam member adapted to be disposed in the receiving chamber, rotatable around a rotary axis, and having
a long end that is a first distance away from the rotary axis, and
a short end that is a second distance away from the rotary axis, the second distance being shorter than the first distance, and
a locking member connected to said cam member and operable for driving rotation of said cam member; and
an actuating unit that is adjacent to said operating unit, and that includes
a base plate adapted to be disposed between said cam member and the open hole of the window frame, and abutting against said cam member, and
a locking rod connected to said base plate, adapted to be aligned with the open hole of the window frame;
wherein said cam member is rotatable about the rotary axis between a first rotational position, where said long end abuts against said base plate, and a second rotational position, where said short end abuts against said base plate;
wherein, when said cam member is rotated to the first rotational position, said base plate is pushed to move said locking rod to a locked position, where said locking rod is adapted to protrude outwardly of the open hole and to engage the engaging slot of the frame portion of the window panel; and
wherein, when said cam member is rotated to the second rotational position, said base plate is released to move said locking rod to an unlocked position, where said locking rod is adapted to be disengaged from the engaging slot.

2. The locking device as claimed in claim 1, wherein said actuating unit further includes a resilient member adapted to be connected between said base plate and an internal surface of the window frame for biasing said locking rod towards the unlocked position.

3. The locking device as claimed in claim 2, wherein said resilient member is a compression spring.
